(19) United States
(12) Patent Application Publication
(10) Pub. No.: US 2008/0217436 A1
(43) Pub. Date: Sep. 11, 2008

(54) Hose nozzle assembly

(76) Inventor: Barbara Owen, Lockport, NY (US)

Correspondence Address: Robert P. Simpson;Simpson & Simpson, PLLC, 5555 Main Street, Williamsville, NY, 14221, US

(21) Appl. No.: 11/715,076

(22) Filed: Mar. 7, 2007

(51) Int. Cl. B05B 7/02

(52) U.S. Cl. 239/526

(57) ABSTRACT

A hose nozzle assembly having a substantially inverted ‘U’ shaped body formed by, in serial order and fluid connection: a nozzle handle; a nozzle spout; and, an attachment. The body is operatively arranged to be removeably secured to an edge of a container. In a preferred embodiment, the assembly further includes a fluid control valve. The fluid control valve is preferably selectively variable and includes a locking mechanism. In an additional preferred embodiment, the assembly further includes a disengageable connection between the hose nozzle and the attachment. Preferably, the disengageable connection is a threaded connection, and most preferably a garden hose connector. In other embodiments, the hose nozzle and attachment are permanently affixed to one another.

### FIELD OF THE INVENTION

The invention relates generally to a hose nozzle assembly, and more specifically, to a garden hose nozzle assembly for filling a container with a liquid.

### BACKGROUND OF THE INVENTION

Nozzles for hoses, especially garden hoses, are well known. Nozzles commonly have a variable fluid control valve for selectively varying water throughput. It is also common for the variable fluid control valve to have a resistive element that maintains the valve in a closed position. The resistance of the valve must be overcome by a user to allow for fluid flow. Common nozzles have a gun-shaped structure with a resistive trigger. Additionally, the control valve may have a lockable element to selectively maintain the fluid control valve in an open position. The lockable element is ideal for filling up large containers with liquids, e.g., water, because it allows the user to leave the nozzle unattended while it fills up a large container.

In practice, a user will commonly place the nozzle, locked in the on position, in a container and allow the container to fill. This is not ideal because the nozzle is usually eventually submerged entirely as the container fills. For water containers, a wet nozzle can become slippery or easily soiled. In colder environments, the movable elements of a nozzle can freeze together. Thus, it is preferred that the nozzle is not submerged in the container intended to be filled.

U.S. Pat. No. 5,887,796 (Dimmer) teaches a hose nozzle that can be secured to the edge of a container to overcome the problems associated with submerging a hose nozzle in a container. Dimmer discloses a dual mode watering nozzle with two selectively adjustable valves and two outlets. Having two valves and two outlets, as taught in Dimmer, increases the complexity of the device, leading to the general drawbacks of difficulty in manufacturing and increases in cost. Problems associated an increase in parts is exacerbated in cold weather conditions, where the individual parts can expand and contract quickly with the flow of water and cause breakage. Furthermore, Dimmer does not disclose a preferable nozzle for use in a farm environment, e.g., horse ranches or farms. The nozzle disclosed in Dimmer can not be used with wide edged horse troughs.

Thus, what is needed then is a hose nozzle attachment assembly having a structural shape arranged for placement over a wall of a container to be filled.

### BRIEF SUMMARY OF THE INVENTION

The present invention broadly comprises a hose nozzle attachment assembly having a substantially inverted ‘U’ shaped body. The substantially inverted ‘U’ shaped body includes, in fluid connection: a nozzle handle; a nozzle spout; and, an attachment. The body is operatively arranged to be removeably secured to an edge or wall of a container.

In a preferred embodiment, the invention comprises an assembly having a fluid control valve. The fluid control valve is preferably selectively variable and includes a locking mechanism.

In another embodiment, the invention comprises an assembly having a disengageable connection between the hose nozzle and the attachment. Preferably, the disengageable connection is a threaded connection, and most preferably a garden hose connector. In another embodiment, the hose nozzle and attachment are permanently affixed to one another.

In yet another embodiment the hose nozzle attachment includes first and second portions. The first portion is arranged substantially parallel to the nozzle spout and the second portion is arranged substantially perpendicular to the first portion. In some embodiments the length of the second portion is at least three inches, but is more preferably at least about five to six inches long.

It is a general object of the present invention to provide a hose nozzle attachment assembly which is simple in construction and comprises few number of parts that can be operatively arranged to be removeably secured to the edge or wall of a container. Additionally, it is an object of the present invention to provide a hose nozzle attachment assembly that can be easily removeably secured to the edge or wall of a container in a manner such that the container can be easily filled with water or liquid transported through the hose nozzle.

It is another general object of the present invention to provide a hose nozzle attachment assembly that reduces the likelihood of injuring animals proximate the assemblies.

It is another object of the present invention to provide a hose nozzle attachment assembly that can be easily used to fill containers of varying sizes and varying edge structures, including wide edges and curved edges.

It is yet a further object of the present invention to provide a hose nozzle attachment assembly, wherein the outer surface of the assembly is operatively arranged to stay dry during use.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken in view of the accompanying drawing figures, in which:

FIG. 1 is a perspective view of the hose nozzle attachment assembly of the invention connected to a hose and removeably secured to a wall of a container, in this case a horse trough shown with a section cut away to show the invention;

FIG. 2 is a second perspective view of the hose nozzle attachment assembly of the invention;

FIG. 3 is a cross sectional view of the hose nozzle attachment assembly shown in FIG. 2 taken generally along line 3-3 of FIG. 2;

FIG. 4 is an exploded view of the hose nozzle attachment assembly shown in FIG. 2;

FIG. 5 is a partial exploded view of the hose nozzle attachment assembly shown in FIG. 2, showing the engagement of a first portion of an attachment to an elbow of the attachment; and,

FIG. 6 is a perspective view of hose nozzle attachment assembly shown in FIG. 2 removeably secured to a hose and positioned onto an edge of a container having a wide, rounded edge.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed embodiments.

Furthermore, it should be understood that this invention is not limited to the particular methodology, materials and modifications described and as such may, of course, vary. It should also be understood that the terminology used herein is for the purpose of describing particular embodiments only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

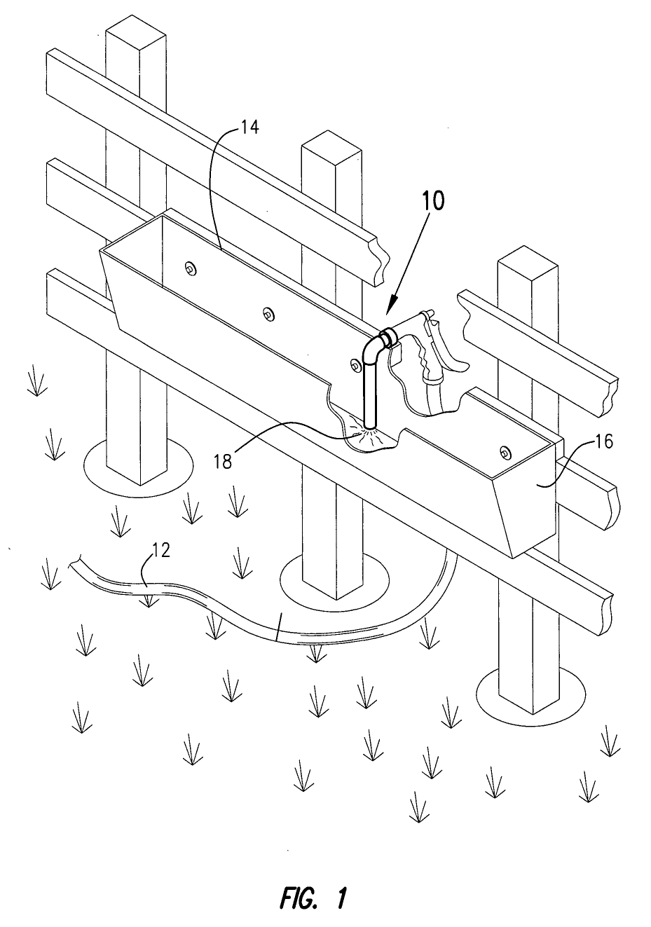

FIG. 1 shows nozzle attachment assembly 10 connected to hose 12 and positioned onto edge 14 of container 16. Container 16 in FIG. 1 is a horse trough, but it should be appreciated that any container could be used with assembly 10. For this particular embodiment, assembly 10 is arranged to fill container 16 with liquid 18, which is water. It should be appreciated, however, that assembly 10 could be used with any liquid.

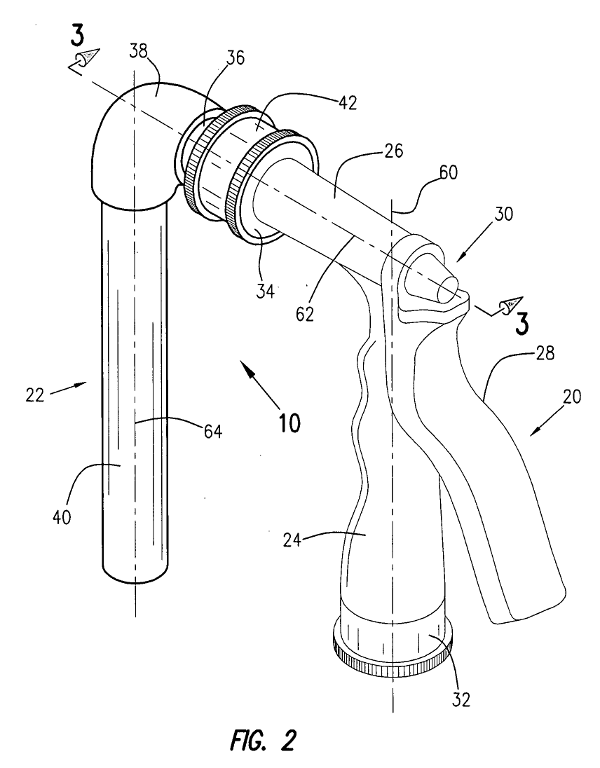

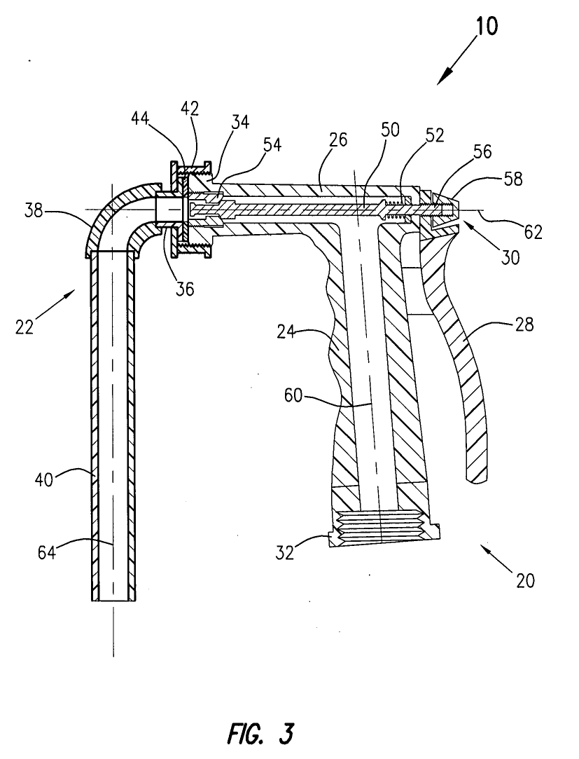

FIG. 2 is a perspective view of assembly 10. Assembly 10 generally includes hose nozzle 20 and attachment 22. Hose nozzle 20 includes nozzle handle 24, nozzle spout 26, trigger 28, locking mechanism 30 and connector 32. Locking mechanism 30 can operatively lock nozzle 20 into a constant ‘ON’ position, which allows continuous flow of the passing liquid (generally water). Locking mechanism 30 is of a locking-nut type. It should be appreciated that any other type of locking mechanism can be used, such as a restraining clip as is known in the art. Hose nozzle 20 is fed liquid through connector 32, which is preferably arranged to engage a standard garden hose through a threaded engagement and is shown in more detail in FIG. 3. Attachment 22 is connected to hose nozzle 20 by means of connection means 34 which is discussed in more detail below.

Trigger 28 is generally arranged such that either liquid pressure, a resistive device such as a spring or a combination thereof, forces nozzle 20 into an ‘OFF’ position. In the present embodiment shown in the figures, nozzle 20 is naturally forced into the ‘OFF’ position by liquid pressure and a spring resistive force, as is shown most clearly in FIG. 3 below. Compressing trigger 28 will place hose nozzle 20 into the ‘ON’ position and allow for the flow of liquid.

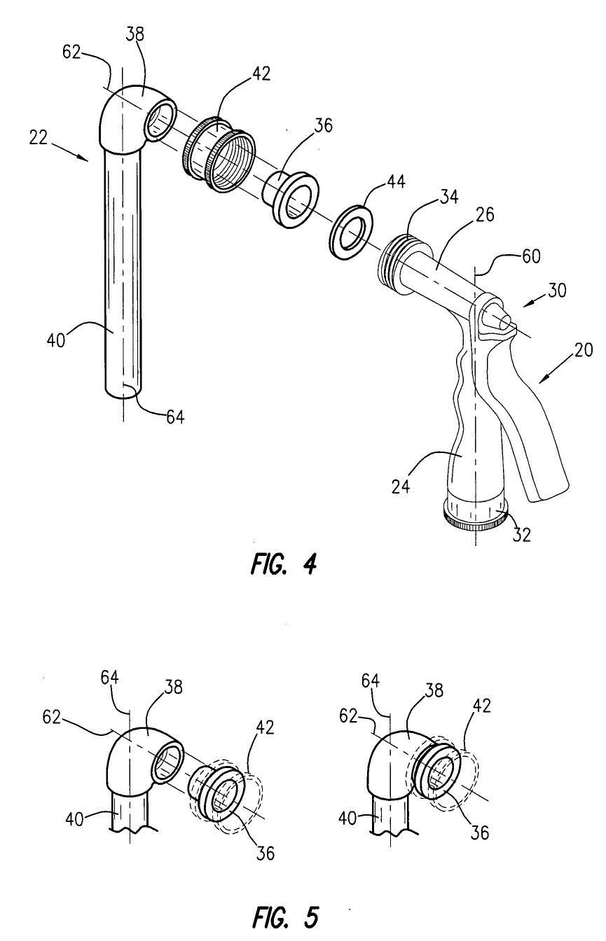

FIG. 2 also shows attachment 22 comprising first portion 36, elbow 38 and second portion 40 to form substantially an “L” shape. Attachment 22 further includes connector 42 for engagement with connection means 34 as is more clearly shown in FIGS. 3 and 4. It should be appreciated that this is only a preferred arrangement to allow attachment 22 to be removeably connected to hose nozzle 20. Alternatively, assembly 10 can be formed from a continuous material, such as a continuously molded plastic or metal, but in a preferred embodiment, assembly 10 is easily broken down into hose nozzle 20 and attachment 22 such that the functionality of hose nozzle 20 by itself is not lost, e.g., the spray functionality. It should be readily apparent that the assembly of the nozzle in combination with attachment 22 generally forms an inverted “U” shape, which makes the assembly ideal for placement over the wall of a container to be filled. The center of gravity of the assembly is located somewhere along spout 26, such that the assembly is essentially balanced when place across the edge or wall of a container.

FIG. 3 is a cross sectional view of hose nozzle attachment assembly 10 shown in FIG. 2 taken generally along line 3-3 of FIG. 2. FIG. 3 shows connection means 34 operatively arranged to engage attachment 22 through a threaded means of connector 42. It should be appreciated that any type of connection could be used, but that the threaded outer surface of connection means 34 and threaded inner surface of connection means 42 is preferred because of the universal threaded standard across common garden and outdoor houses. These respective threaded surfaces are shown more clearly in FIG. 4. Between the front surface of connection means 34 and the front surface of first portion 36 is sealing ring 44, which facilitates a non-leaky connection between hose nozzle 20 and attachment 22.

FIG. 3 most clearly shows the operational structure of compressing trigger 28 opening fluid control valve 50 to an ‘ON’ position. Springs 52 exert a pressure onto valve 50 so that valve 50 naturally rests in the ‘OFF’ position where valve 50 rests in valve seat 54 and seals fluid flow. Valve 50 includes threaded end 56 for engagement with locking nut 58 of locking mechanism 30. It should be appreciated that the operational structures of hose nozzle 20 as shown in FIG. 3 and presently discussed are not essential to the invention. Any number of hose nozzles known in the art, especially those having dissimilar locking mechanisms and trigger devices, can be adequately used with attachment 22 so long as the overall structural arrangement of hose nozzle 20, attachment 22 and their combination adheres to the elements of the invention as will be discussed in detail below.

FIGS. 2-4, but especially FIG. 3, generally illustrate nozzle handle 24 positioned substantially axially along axis 60. Nozzle spout 26 and first portion 36 are positioned substantially axially along axis 62, and second portion 40 is positioned axially substantially along axis 64. Serially connected, axes 60, 62 and 64 form a substantially inverted ‘U’ shape. Correlatively, nozzle handle 24, nozzle spout 26, first portion 36 and second portion 40 are arranged to form a substantially inverted ‘U’ shape in accordance with the claimed invention.

Preferably, nozzle handle 24 is positioned substantially axially along axis 60 at an incline relative to a perpendicular intersection with axis 62 and a parallel with 64 as is shown in the drawings, especially FIGS. 2 and 3. This incline offers a more comfortable operation of the hose nozzle when hand operated. This incline is variable within the scope of the invention just so long as the general shape formed by nozzle 20 and attachment 22 is substantially an inverted ‘U’ shape.

In order to facilitate the removeable securing of assembly 10 to the edge of a container, second portion 40 is preferably at least about three (3) inches long but smaller lengths can still be operable. Most preferably, second portion 40 is at least about five (5) to six (6) inches long.

FIG. 4 is an exploded view of the assembly shown in FIG. 2, detailing the arrangement of connection means 34 and connector 42 in relation to first portion 36. Sealing ring 44 is shown in greater detail, together with its arrangement between connection means 34 and first portion 36 to facilitate a non-leaky connection between hose nozzle 20 and attachment 22.

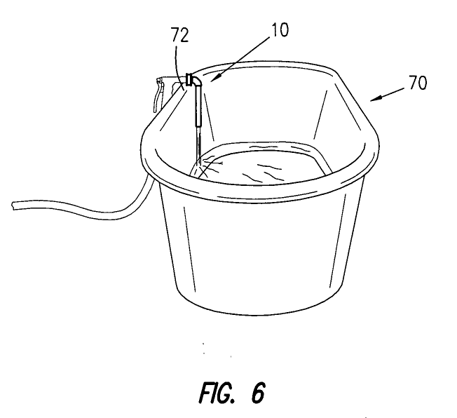

Connector 42 surrounds the end of first portion 36 as shown most clearly in FIG. 5. FIG. 5 is an exploded partial view of attachment 22, showing the engagement of first portion 36 to elbow 38 in relation to connector 42 shown in dashed lines. First portion 36 is connected to elbow 38 by means of an adhesive, but any connection means suitable can be used. First portion 36, elbow 38 and second portion 40 can also be formed of a singular, molded piece as well. First portion 36, elbow 38 and second portion 40 are preferably made from plastics, but any other material suitable for piping can be used.

The substantially inverted ‘U’ shaped structure of apparatus 10 provides a hook-like removeable securing means for apparatus 10 to engage with the edge of a container, such as container 16 shown in FIG. 1. The substantially inverted ‘U’ shaped body of apparatus 10 is arranged such that it can accommodate a variety of differently shaped container edges. Many containers, especially water containers for animals in a farm setting, however, have wide edges that are often arcuately shaped to increase container rigidity and to reduce the likelihood of animals injuring themselves. It should be appreciated that apparatus 10 is also suitable for filling a swimming pool, hot tub, or any other liquid holding container.

As shown in FIG. 6, apparatus 10 is removeably secured to container 70 at edge 72. Edge 72 is common to water containers for horses in an outdoor setting wherein edge 72 is wider than edges commonly seen for smaller containers and edge 72 is a rounded edge to reduce the likelihood of animal injury when using container 70. Although common for use with horses and other animals in farm settings, it should be appreciated that a variety of other containers for non-water or non-animal purposes have similarly rounded edges and could be used with apparatus 10.

The substantially inverted ‘U’ shape of apparatus 10 allows the apparatus to be removeably secured to a variety of different edges available for containers and allows for simple manipulation. Apparatus 10 is arranged such as to provide for easy removal from the edge of a container so as to both reduce the likelihood that apparatus 10 is damaged by animals using the container and that an animal is less likely to injure itself if it moves into apparatus 10 or nudges apparatus 10 with its head. Furthermore, this assists a user in repositioning apparatus 10 or relocating apparatus 10 to an additional container easily without having to specifically align any small structural components.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A hose nozzle assembly, comprising:
a nozzle having an inlet port and a handle;
a nozzle spout in fluid communication with said inlet port, said nozzle spout arranged substantially perpendicularly to said nozzle, said nozzle spout having a single outlet port; and, an attachment arranged substantially perpendicularly to said nozzle spout and in fluid communication therewith, and arranged substantially parallel to said nozzle,
wherein, said nozzle, nozzle spout and attachment together form a substantially inverted ‘U’ shaped body.

2. The hose nozzle assembly as recited in claim 1, said nozzle handle further comprising a garden hose connector.

3. The hose nozzle assembly as recited in claim 1, wherein said nozzle spout and said attachment are permanently affixed to one another.

4. The hose nozzle assembly as recited in claim 1, further comprising a fluid control valve.

5. The hose nozzle assembly as recited in claim 4, wherein said fluid control valve is a selectively variable fluid control valve.

6. The hose nozzle assembly as recited in claim 5, further comprising a lock for said selectively variable fluid control valve.

7. The hose nozzle assembly as recited in claim 1, further comprising a disengageable connection between said nozzle spout and said attachment.

8. The hose nozzle assembly recited in claim 1 wherein said attachment comprises an elbow and straight pipe section secured to one another.

9. The hose nozzle assembly as recited in claim 7, wherein said disengageable connection is a threaded connection.

10. The hose nozzle assembly as recited in claim 1, said attachment further comprising first and second portions, said first portion arranged substantially parallel to said nozzle spout and said second portion arranged substantially perpendicular to said first portion.

11. The hose nozzle assembly as recited in claim 10, said second portion having a length of about at least three inches.

12. The hose nozzle assembly as recited in claim 10, said second portion having a length of about at least five to six inches.

13. A hose nozzle assembly, comprising:
a substantially inverted ‘U’ shaped body, consisting in serial order and fluid connection: a nozzle handle; a nozzle spout having a fluid control valve and an attachment connection means; and, an attachment, said nozzle spout connected to said attachment by said attachment connection means,
wherein, said substantially inverted ‘U’ shaped body is operatively arranged to be removeably secured to an edge of a container.

14. A hose nozzle attachment assembly, comprising:
a substantially inverted ‘U’ shaped body, comprising in serial order and fluid connection: a nozzle handle; a nozzle spout having a trigger-type selectively adjustable fluid control valve and an attachment connection means; and, an attachment, said nozzle spout connected to said attachment by said attachment connection means,
wherein, said substantially inverted ‘U’ shaped body is operatively arranged to be removeably secured to an edge of a container.
